(19) United States
(12) Patent Application Publication
(10) Pub. No.: US 2007/0051797 A1
(43) Pub. Date: Mar. 8, 2007

(54) Methods and systems for packaging and distributing financial instruments

(76) Inventors: Ronald Randolph-Wall, Incline Village, NV (US); Alfred Pariser, Rancho Mirage, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/508,115

(22) Filed: Aug. 22, 2006

Related U.S. Application Data
(60) Provisional application No. 60/710,101, filed on Aug. 22, 2005.
(60) Provisional application No. 60/798,946, filed on May 9, 2006.

(51) Int. Cl. G06F 7/08; G06Q 30/00; G06F 17/00; G06Q 40/00

(52) U.S. Cl. 235/381; 700/231; 705/14; 705/39

(57) ABSTRACT

A card dispensing apparatus is described herein. A product package is provided that contains a consumable or a non-consumable. A debit card or a credit card having a magnetic stripe is removably positioned in the product package, and/or removably coupled to the product package. The card can be coupled to the package using an adhesive or other coupling mechanism.

### PRIORITY CLAIM

This application claims the benefit under 35 U.S.C. 119(e) of U.S. Provisional Application No. 60/710,101, filed Aug. 22, 2005, and U.S. Provisional Application No. 60/798,946, filed May 9, 2006, the contents of which are incorporated herein in its entirety.

### COPYRIGHT RIGHTS

A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to systems and methods for packaging cards to methods and systems for processing information accessed therefrom.

2. Description of the Related Art

Credit and charge cards are commonly used by consumers when making purchases. Conventionally, a consumer may need to be approved (e.g., the consumer may need to meet certain credit history criteria), before a financial institution (e.g., such as a bank or other financial institution) will issue the consumer a credit card. For example, a credit card issuer may require that a consumer fill out a credit card application form listing the consumer's residence and income. The form, or related documentation, may disclose to the consumer disclosing terms and conditions associated with the credit card product, such as whether there is an annual fee, the associated interest rate and finance charges, the associated credit limit, and the like.

Once approved, credit cards and charge cards are typically mailed to the consumer, often with the same or additional disclosure information being provided as well. Thus, conventionally, the consumer's identity, address information, and other information, needs to be known, and the consumer needs to be approved, before a credit card is issued to the consumer.

With a credit card, an authorized consumer can purchase goods and services, wherein the credit card issuer loans the consumer the funds for the purchase. The consumer incurs debt corresponding to the amount funded. Conventionally, the consumer pays off some or all of the debt upon receipt of a monthly statement from the credit card issuer.

The total amount of funds available to a consumer via a credit card is often limited to a maximum amount, the “credit limit”, predetermined by the credit card issuer. Thus, a credit card may be issued with an initial credit limit. The credit limit is often determined by the credit card issuer based on the consumer's credit history and/or the consumer's income. As the consumer uses the credit card to charge purchases, the available portion of the credit limit is reduced by the purchase amount.

Conventional approaches typically involve the card issuer tracking the account balances of many customers, determining if interest and/or financing fees are due, applying deposits for secured credit cards, and instituting collection efforts with respect to large numbers of defaulters.

A debit card is another alternative to using cash when making a purchase. Conventionally, when a purchase is made with a debit card, the funds for the purchase are withdrawn directly from the purchaser's checking or savings account at a bank.

A debit card can be compatible with the personal identification number (PIN) authentication system, such as those used by automated teller systems. A debit resulting from a purchase is reflected in the user's account balance immediately. Thus, for example, a keyboard may be provided via which the user can enter their PIN. Transactions involving a debit card PIN are sometimes referred to as online transactions. Rather than using a PIN, some debit cards have the user sign a receipt to authorize a transaction. Such debit cards may be subject to a daily limit and a maximum limit equal to the amount currently deposited in the account from which it draws funds. Such transactions, not involving a debit card PIN, are sometimes referred to as offline transactions. Some debit cards allow transactions to be authorized using either a PIN or a signature.

Conventional debit and credit cards generally have the shape and dimensions as specified by the International Standards Organization ISO 7810 and 7813. For example, conventionally, credit cards may have the following dimensions: 85.60 mm×53.98 mm×0.76 mm, with the corners rounded, such as with a radius of 3.18 mm. A conventional credit card may include a magnetic stripe 0.56642 centimeters from the edge of the card, wherein the stripe is conventionally 0.9525 centimeters wide. Such uniformity allows for a credit card swipers and readers to read or take imprints of credit cards from multiple issuers.

### SUMMARY OF THE INVENTION

Discussed herein are systems and methods packaging cards, such as financial cards, terminals for scanning or reading financial instruments, methods and systems for processing information accessed therefrom.

In addition, as described herein, certain example embodiments provide for the distribution of a financial instrument without requiring a credit check or a bank account for the end user and without knowing the identity of the end user. The financial cards can be one-use cards, multiuse cards, or reloadable cards. The cards can optionally be distributed with a zero initial value. The cards can optionally be distributed with consumer products. The cards optionally are non-ISO compatible and can physically resemble something other than a credit or debit card. An example card reader is described which can be used to swipe and read the non-ISO compatible card. Certain embodiment provide credit card or debit card-like financial instruments on a low cost media, such as paper.

An example embodiment provides a card dispensing apparatus, comprising: a product package that contains food, a cleaning product, an electronic entertainment device, and/or media storing a movie or music; and a debit card or a credit card having a magnetic stripe, wherein the card is removably positioned in the product package and/or removably coupled to the product package.

An example embodiment provides a card tracking system, comprising: at least a first data store configured to store: a card identifier for a first debit or credit card; at least a first merchant identifier that indicates at which merchants and/or merchants categories the first card is authorized for use at; a value amount associated with the first card; wherein the data store does not include information identifying a card recipient prior distribution of the financial card to the recipient, and stores information that identifies the card recipient using information received from the recipient after distribution of the financial card to the recipient; and an interface configured to receive user identification information, first card identification information, and information related to a brand provided by the first user after the first user receives the first card.

An example embodiment provides a method of distributing a debit card: causing a first debit or credit card to be distributed via product packaging, mail, or a dispensing machine, wherein the first card does not have an end user name printed thereon; storing a use indication indicating how many times the first card can be used to make purchases before the first card is disabled from making further purchases; storing an indication as to the amount the first card is funded for or is to be funded for in making a transaction; causing funds to be transferred to fund the purchase transaction to the lesser of a transaction amount for a first transaction made using the first card and the funding amount; and causing a determination to be made if further use of the card in financial transactions is to be disabled based at least in part on the use indication.

An example embodiment provides a method of securely activating a financial card, the method comprising: receiving over a network a user identifier, user location information, and a financial card identifier for a financial card, wherein the financial card is a credit card or a debit card; validating the financial card identifier; reading a first set of eligibility information indicating at which merchants and/or merchant types the financial card are eligible to receive payment for transactions made using the financial card; storing financial card identification information in association with the user identifier; based at least in part on the user location information and eligibility information, determining if there are merchants within a first geographical area at which the financial card can be used; if there are eligible merchants within the first geographical area, providing over the network location information regarding at least a first of the merchants to the user; and if there are not eligible merchants within the first geographical area, enabling the use of card at a different merchant and/or merchant type based on a second set of eligibility information.

An example embodiment provides a card dispensing apparatus, comprising: a product package that contains food, a cleaning product, an electronic entertainment device, and/or media storing a movie or music; and a debit card or a credit card including a data storage device readable without physically contacting the data storage device, wherein the card is removably positioned in the product package and/or removably coupled to the product package.

An example embodiment provides a method of distributing a financial instrument, the method comprising: providing a consumer with an authorization code via a product package, a product label, a coupon, or via a receipt for purchasing at least a first product or service; receiving over a network the authorization code from the consumer; determining if the authorization code is valid; receiving over the network personal data from the consumer; identifying to the consumer establishments that accept a first financial instrument, wherein the first financial instrument is a debit instrument or a credit instrument; storing a code associated with the first financial instrument in association with an identifier associated with consumer; electronically providing over the network the first financial instrument to the consumer, wherein the financial instrument is configured to be printed using a printer coupled to a terminal.

An example embodiment provides a method of distributing a financial instrument, the method comprising: providing a consumer with an authorization code; receiving over a network the authorization code from the consumer; determining if the authorization code is valid; and electronically providing over the network a first financial instrument to the consumer, wherein the financial instrument is printable by the user using a printer coupled to a terminal.

### BRIEF DESCRIPTION OF THE DRAWINGS

Exemplary embodiments are illustrated in the accompanying drawings, which are for illustrative purposes only. The drawings comprise the following figures, in which like numerals indicate like parts.

FIG. 1 illustrates an exemplary system environment.

FIG. 2 illustrates an example flow chart process for issuing limited use financial card.

FIG. 3 illustrates an example flow chart process for a limited use financial card.

FIG. 4 illustrates an example flow chart process for a re-loadable financial card.

FIGS. 5A-B illustrate example user interfaces used to collect information related to a financial card and a financial card holder.

FIG. 6 illustrates an example card reader.

FIGS. 7A-B illustrate an example physical configuration of a financial card.

FIG. 8 illustrates an example product package with an example attached financial card.

FIG. 9 illustrates an example process related to a prepaid certificate.

### DETAILED DESCRIPTION OF PREFERRED EMBODIMENTS

The present invention relates generally to systems, methods, and apparatus for packaging financial instruments, such as credit or debit cards, electronically reading and issuing financial instruments, and to the secure funding of financial instruments. The cards can optionally be distributed with consumer products. The cards optionally are non-ISO compatible and can physically resemble something other than a credit or debit card. An example card reader is described which can be used to swipe and read the non-ISO compatible card. The financial cards can be one-use cards, multiuse cards, and/or reloadable cards. The cards can optionally be distributed with a zero initial value.

Throughout this disclosure, the term “website” is used to refer to a user-accessible server site that implements the basic World Wide Web standards for the coding and transmission of hypertext documents. These standards currently include the hypertext markup language (HTML) and the hypertext transfer protocol (HTTP). The term “site” is not intended to imply a single geographic location, as certain websites or other network sites include multiple geographically distributed computer systems that are appropriately linked together. Furthermore, while this disclosure describes certain embodiments that use the Internet and related protocols, other networks, such as networked interactive televisions, and other protocols are used in other embodiments.

Additionally, unless otherwise indicated, the functions described herein are performable by software including executable code and instructions running on one or more general purpose computers. In an exemplary embodiment, the computers include one or more central processing units that execute program code and process data. The computers also include memory, including one or more of volatile memory (such as random access memory for temporarily storing data and data structures during program execution), non-volatile memory (such as a hard disc drive, optical drive, or flash drive, for storing programs, data, and databases), and one or more network interfaces for accessing an intranet and/or Internet.

The computers optionally include a display for displaying user interfaces, data, photographs, images, and the like. In certain embodiments, the computers also include one or more user input devices, such as a keyboard, mouse, pointing device, microphone and the like, used to navigate, provide commands, enter information, and the like. However, other embodiments are implemented using special purpose computers, state machines, and/or hardwired electronic circuits. Additionally, the example processes described herein do not necessarily have to be performed in the described sequence, and not all states have to be reached or performed.

Furthermore, where this disclosure refers to “clicking on” a link or button, or pressing a key in order to provide a command, make a selection, or to provide data, in other embodiments the commands, selections, and data input are made using other input techniques, such as using voice input, pen input, or mouse input, including hovering over an input area, selecting menu options, and the like. In addition, while several of the examples described herein are with reference to certain types of financial instruments (e.g., a debit or credit card) card, other financial instruments (e.g., smart cards, charge cards, etc.) can be used as well.

While certain embodiments refer to the use of magnetic media (e.g., magnetic stripes) for storing data and to magnetic readers to read the magnetic media, other types of storage devices and readers can be used as well. For example, a “non-contact” storage device, such as an RFID (radio frequency identification) tag or other device, can be used to store data discussed below, and an RFID reader can be used to read the data, without having to be physically in contact with the tag or the carrier medium (e.g., a plastic, cardboard, an item package, other carrier material, etc.) bearing the tag (e.g., to which the tag is affixed). In addition, while certain example shapes and dimensions are discussed below, other shapes and other dimensions can be used as well. Further, while the phrase “account number” and the like may be used herein, the phrase “account number” is not limited to only numeric account identifiers, but the account identifiers can include alphanumeric characters, icons, or still other account identification representations.

One example embodiment provides for the distribution of a financial instrument, such as debit card or a credit card, without requiring a credit check or a bank account for the end user. Optionally, the debit card or the credit card can be issued without the issuer knowing or receiving the end user's name and without having an end user's name printed on the card. The debit card or the credit card can be issued by a card issuer, such as a bank or other financial institution.

In an example embodiment, a financial card, such as a debit or credit card, can be packaged in conjunction with a consumer product, such as a box of cereal, a household cleaner, an article of clothing, a DVD, electronic entertainment equipment, or otherwise. For example, the card can be inserted into a product package (e.g., a box, bag, or can), or the card can be glued or otherwise affixed to the outside of the product packaging. The product with which the card is packaged can be sold at a merchant, such as a retail store or an online store. For example, the product (including the product packaging and card) can be placed and positioned on a retail store product shelf so that a consumer can view, retrieve, and purchase the product. The packaging can be, by way of example, a card board box, a bottle, a plastic container, shrink wrapping, a sealed or non-sealed bag, and/or other type of packaging.

Payment for purchases made using the financial card is optionally paid for and/or guaranteed by a third party (e.g., an operator of a financial card processing system, also referred to as a system operator), rather than the card issuer or the end user consumer.

Optionally, the third party can deposit funds in an escrow account from which payment will be made for financial transactions, such as purchases, made by the end user using the card.

For example, the funds can be deposited in an account at a financial institution (e.g., a bank) associated with the financial card issuer (e.g., the same bank where the escrowed funds are deposited). Optionally, funding takes place at the time the card is used. For example, if the card is a debit card, optionally, as soon as the issuing financial institution receives an authorization request, or some time thereafter, funds can be withdrawn from the escrow account and assigned to the card in an amount corresponding to the transaction amount, or a designated portion thereof. Thus, optionally, the end user will not receive a bill or invoice for charges made using the financial card.

Optionally, if the card is a credit card, the card can have been issued with a zero credit limit. When a user makes a purchase or after the third party activates the card, the credit limit of the card can be raised from zero to an amount corresponding to the transaction amount or to some other maximum amount. Funds from the escrow account can optionally be withdrawn and used to cover the transaction amount.

In another example embodiment, if card is a debit card, the card initially has a zero value. Optionally, if the card is a credit card, the credit card can initially have a credit limit of zero, wherein the card cannot be used to initially to make any purchases. The user is optionally required to take a certain action, such as performing an online or telephonic registration process before the debit card can be used, or before the credit card credit limit is raised. For example, if a user attempts to use the debit or card cards before they have been activated, the merchant will receive a “declined” notification.

By way of illustration, the debit card value or credit limit can be set or specified by the third party funding entity. For example, the debit card limit or credit limit can be selected to cover, and be limited to, approximately the estimated purchase price (e.g., the estimated high end purchase price, the estimated average purchase price, the estimated mean purchase price, the estimated low end purchase price, etc.) of a selected item, such as a movie ticket, a record album, a movie DVD, and so on, optionally including related taxes and fees. For example, the debit card value or credit limit can be selected to be equal to the estimated high end price of a movie ticket (e.g., $9.50), optionally plus an expected high end (e.g., 10%) of a related tax (e.g., a sales, service, or entertainment tax).

Optionally, the card can have a specified use period, (e.g., the card needs to be used before a specified date, or needs to be used within a specified range, such as a range beginning on a specified start date and ending on a specified end date), wherein the card cannot be used outside of the specified period, and/or is cancelled/expires after a specified date. For example, if the card is intended to promote a movie, the card may be set to expire one month or two months after the general release of the movie.

Optionally, the amount deposited in the third party escrow account can be set equal to, or be based on, the number of financial cards distributed multiplied by the corresponding maximum debit card value/credit limit for each card associated with the escrow account. Optionally, an estimate can be made as to the percentage of cards that will actually be redeemed, and the escrow amount can be set equal to, or be based on, the number of financial cards distributed multiplied by the corresponding maximum credit limit/debit card value for each card associated with the escrow, multiplied by the expected redemption percentage.

The financial card can optionally be a one-use credit card, wherein the user who obtains the financial card can only make one purchase with the financial card, and then, optionally, the financial card is cancelled and further attempted uses will be declined by the card issuer. Optionally, the one use can be limited to use at a particular store, a particular type of store, or for a particular product or service, such as for a movie theater ticket, DVD, or media download. For example, the financial card is optionally authorized for use only at merchants having a specified Merchant Category Code (MCC) (which indicates the vendor type, such as the nature of the merchant's business) or a specified Merchant ID or other merchant identifier. Thus, optionally, a transaction being made with the financial card will only be approved via an authorized payment processor if the card is being used at designated or selected merchants or merchant locations, which can be determined via electronic filtering of a merchant ID and/or MCC codes provided during a financial card transaction. The merchant ID code and/or MCC are provided via the merchant financial card terminal or otherwise during a financial card transaction.

By way of illustration, an example financial card may be a one-use card having a credit or debit card limit of $9.50, wherein the financial card is limited to, or specified to be used to purchase a movie ticket. If the user attempts to use the financial card for other purposes, such as to purchase a hammer at a hardware store, the charge will be declined by the authorized payment processor. The user can use the financial card to purchase a movie ticket (e.g., for $7.50, for $8.00, or for $9.50), and the financial card will then be cancelled (e.g., not further funded) or its use disabled, even if the amount charged to the card is less than the credit limit or available debit card value existing at the time the purchase was made. Thus, a user is optionally prevented from utilizing a residual value or use beyond program rules established by the financial card processing system operator or its corresponding clients.

The foregoing process can resolve the potential issue that would result if the card had an authorized maximum “up-to” value, where the amount of the authorized maximum “up-to” value of a financial card not used for the “one use” (e.g., the authorized amount in excess of the actual cost of a movie admission) might be deemed as owned by the cardholder and therefore an escheatable value. The example card with an optional initial zero value, as described herein, avoids this problem, as the card is not actually loaded with value other than what is needed to fund the actual cost of the designated one use. At that point, the remaining funds (the difference between authorized maximum price and redemption cost), which were “notational” and reflective of a card's purchase range, remain in the control of the financial card system operator and/or its clients.

Optionally, the user can purchase an item for more than the debit or credit card limit, wherein the amount over the limit is paid using a different payment instrument (e.g., another financial card, a debit card, cash, a coupon, etc.). Payment for the charge, up to the card limit, is optionally made using funds from the third party escrow account discussed above.

Optionally, once the cards associated with the third party escrow account have been used, cancelled, and/or expired, and the actual charges have been paid for via funds from the third party escrow account, the remainder of the escrow account, or a selected portion thereof, can be returned or credited to the third party (optionally, including a recipient designated by the third party).

In another example embodiment, the card can be used multiple times up to the card limit, and some or all of the related charges can be paid, optionally without canceling the card. The user can thus continue making purchases using the card, up to the unused card limit. In addition or instead, the card can be reloaded with additional value after a given use. Optionally, the credit card is reloaded with value (e.g., at least a portion of the card balance is paid off and/or the card limit is increased) in response to the user performing a predetermined designated act (e.g., the purchase of a certain item, the purchase of a certain item type, a purchase having at least a predetermined value, meeting certain attendance standards, working a certain amount of overtime, etc.), or at a predetermined time or interval.

By way of further example, if the user uses the card at a designated event, such as a movie, the card is optionally reloaded with additional value, such as an amount sufficient to purchase a movie ticket. By way of further example, a card reload can be initiated by one or more clients seeking to provide the user with an incentive to purchase an item or service manufactured by, distributed by, sold by, or promoted by the corresponding client.

A plurality of cards can be issued as a group. For example, a group of cards can be associated with a specific, designated third party escrow account. The third party can optionally establish multiple escrow accounts which are associated with corresponding sets of cards.

By way of further example, the third party may cause a set of cards to be issued as part of a marketing campaign (e.g., a client marketing campaign to promote a movie, a book, an album, or other product or service), and/or as a client's employee incentive or reward. Further, for example, the third party can optionally issue multiple sets of cards, wherein a given set of cards is associated with a specific marketing campaign or employee incentive campaign. Thus, the cards can act as promotional reward cards that, for example, can be used to reward prospects, customers, employees or employees of a client's distributors and/or retailers.

By way of illustration, the system operator can have clients (e.g., manufacturers, marketing companies representing manufacturers, service providers, employers, retailers, distributors, governmental entities, etc.) which, via the card distribution system described herein, can offer cards to their constituents (e.g., prospects, customers, employees or employees of their distributors/retailers, etc.) as an incentive or a thank you item. For example, the clients can provide the card to customers that have ordered a certain item, or placed an order having a certain dollar value. Employers can provide the card to an employee as a reward for being on time a certain number of days, for having worked for the employer for a certain number of years, or for completing a certain task.

The cards are optionally distributed with printed promotional materials (and/or electronic or optically stored versions thereof) promoting the item or service (e.g., a movie, a book, music, clothing), or describing an activity being rewarded (e.g., improved employee performance, improved sales performance, etc.), or the activity being incentivized. Optionally, the promotional information and usage restrictions are printed (e.g., silk screen on, emboss, or otherwise cause to be visible) on the card.

For example, the materials optionally state that the card may be proffered at an entity that accepts the card (e.g., a MasterCard® or VISA® merchant) for specified goods and/or services up to a stated value (e.g., a free movie admission, $10.00 towards the purchase of a DVD, $12.50 towards a haircut, $5.00 towards the purchase of toys, etc.), up to a stated date.

The cards can optionally be dispensed by being packaged with products (e.g., food, clothing, cleaning supplies, office supplies, optical media, video cassettes, electronic products, etc.), dispensed by a human (e.g., at a retail store, a public sidewalk, at a mall, at a financial institution, at the facility at which the card recipient is employed, etc.), distributed via mail, or dispensed via a mechanical or electro-mechanical dispensing terminal.

By way of further example illustration, a card can optionally be distributed using one of the following techniques:

1. A card can placed inside the packaging of branded products (“in-packed”). Optionally, the product can be associated with an item being promoted via the card. For example, the card can be intended to be used to purchase a movie ticket for a specific movie, and the product can be a food product having an image of characters or scenes from a movie being promoted printed on the food product packaging. Optionally, the card can likewise optionally have an image associated with the movie (e.g., an image of a movie character or movie scenery), or other product being promoted, printed thereon. The image can be licensed from the corresponding movie studio or other copyright owner or licensor. Optionally, the image printed on the product package can be of the same movie character or scenery as the product packaging. Optionally, the card is distributed with no initial value and is not yet authorized for use. The card holder (e.g., the product purchaser) name is optionally not yet known to the card issuer, the third party, or a related entity, and the card holder name is not imprinted on the card. Optionally, a card number is embossed, printed, on, lasered on, and/or otherwise displayed on the card face. For example, the card number can be 12, 16 or other number of digits long, and can include a system number, a bank number, an account number, and/or a check digit. Optionally, the card number is a unique card number. Optionally, the card can include a magnetic stripe, bar code, RFID device, or other data storage device that stores some or all of the following information:
Country code (optionally, a 3 character code);
Name (optionally the name of the system operator, the client on whose behalf the card is being issued, and/or a promotional campaign name);
An expiration date code;
Discretionary data (optionally the name of the system operator, the client on whose behalf the card is being issued, and/or a promotional campaign name, or other information);
Longitudinal Redundancy Check (LRC) or other code used to detect and/or correct errors in data stored on the magnetic stripe;
Primary account number (e.g., an account number associated with the system operator, a system operator client, and/or other appropriate entity).

2. The card is physically handed to a consumer upon completion by the consumer of the desired behavior. For example, the consumer may be provided with a card (e.g., the one-use card or the multiple use card described herein) if the consumer purchases a certain item, a certain quantity of items, or makes of purchase having a certain dollar value. By way of illustration, if a consumer purchases $200 worth of groceries at a store (or has performed other specified purchases), the consumer is optionally informed by a cashier that a spend threshold has occurred, and is handed a card or is informed that the consumer can claim the card (“reward”) at the store's service desk or at another designated location. The card optionally has one or more of the properties discussed above with respect to distributing an in-packed card. For example, optionally, the card is distributed with no value and is not yet authorized for use. The card holder (e.g., the product purchaser) name is optionally not yet known to the card issuer or system operator and is not imprinted on the card. Optionally, a card number is embossed, printed, on, lasered on, or otherwise displayed on the card face. Optionally, the card can include a magnetic stripe or other data storage device that optionally stores some or all of the information discussed above and/or additional information.

3. The card is mailed to a consumer (e.g., as a reward for completion by the consumer of the desired behavior or as an incentive to perform as certain behavior). By way of example and not limitation, the card may be mailed out to the consumer when the consumer makes a requisite number of purchases and/or mails in proofs of purchase, when the consumer has made a certain dollar value worth of purchases of a product, when the consumer has made a purchase from a certain merchant, when the consumer has purchased a certain item or an item from a certain class of items. The card optionally has one or more of the properties discussed above with respect to distributing an in-packed card. For example, optionally, the card is distributed with no value and is not yet authorized for use. The card holder (e.g., the product purchaser) name is optionally not yet known to the card issuer or system operator, and the card holder name is not imprinted on the card. Optionally, a card number is embossed, printed, on, lasered on, or otherwise displayed on the card face. Optionally, the card can include a magnetic stripe or other data storage device that optionally stores some or all of the information discussed above and/or additional information.

The third party, sometimes referred to herein as the “system operator”, can handle card activation, collect card user demographics (e.g., consumer age, consumer income, consumer's household income, consumer family size, number of adults and children in the consumer's household, the consumer's spending habits, the consumer's gender, age, etc.), contact information (email address, physical address, phone number, etc.), monitor and/or enforce rules compliance that may be associated with the card use, maintain a program web site associated with a marketing or employee incentive plan, maintain a call center for consumer inquiries, gather market information, provide communications to cardholders, communicate with loaders of additional financial rewards on the card, handle funding of the cards, etc. By way of further example, the system operator can generate reports including some or all of the gathered information, and provide such reports to clients.

The cards may be issued by an independent issuer (e.g., a merchant) or an issuer (e.g., a bank or other financial institution) associated with an association, such as VISA®, MasterCard®, or other association. A card association may own and operate branded card networks and manage a merchant payment network to settle payments with accepting outlets and reimburse an accepting merchant (or other entity) when a card, such as those described herein, is presented for the exchange of goods and services.

The issuer issues the sets of cards, optionally in accordance with rights and obligations established by or with the card associations of which the issuer is a member. The issuer can handle fund and settle transactions through the card association's payment network.

For example, optionally, a payment processor/acquirer receives payment requests from a payment network associated with a given credit card association. The payment processor/acquirer checks the transaction for validity and the data stored on the magnetic stripe. For example the acquirer may check a merchant identifier (Merchant ID), the card number to make sure it is valid, the card expiration date, the card limit, and/or card usage.

The payment processor processes these requests by obtaining funds from the issuer (e.g., a bank or other financial institution), and flows these funds back through the association's payment network so as to reimburse the entity (e.g., the merchant) that accepted the charge. The issuer deducts the amounts corresponding to the payment requests from the escrow account associated with the system operator. The escrow account is optionally funded using funds from the client on whose behalf the card was issued. Optionally, unused escrow funds, or a portion thereof, are returned to the client. Optionally, instead, unused escrow funds, or a portion thereof, are kept by the card processing system operator or an affiliate thereof. By way of example, escrow funds may go unused because not all users activated their cards and/or because the cards are one-use cards, and users purchased items for less than the one-use card limits.

As previously discussed, the card is optionally initially issued to a user with a zero value. The user optionally accesses a Web site (e.g., using a computer, interactive television, phone, or other terminal) via which the user can activate the card. The Web site is optionally hosted by the card processing system. Optionally, a URL or other address of the Web site via which the card can be activated is printed on the card in human readable characters, embedded in a scannable bar code on the card, stored in computer readable memory, or otherwise stored on the card. A user terminal can optionally read or scan the Web site address and automatically present the corresponding Web page on the user terminal. For example, the Web site can be operated by or on behalf of the third party system operator discussed above.

The user may be asked to provide some or all of the following information in order to have the card activated: the card number or other identifier printed on the card, the user name, address, email address, phone number, SMS address, instant messenger identifier, and other information (e.g., demographic information, such as age, gender, income, household size, etc.), which is then stored in a system database. The user may also asked to provide the user's opinion regarding one or more brands, the user's familiarity with the brand, how often the user purchases an item associated with the brand, the user's opinion regarding the quality of products associated with the brand, would the user recommend the brand, how the brand compares with other brands in the same field, and so on.

As similarly discussed above, some or all of the foregoing information can be provided to the client (if any) on whose behalf the card is being issued, via a report transmitted electronically to the client (e.g., via email or a Web page), and/or in a printed form. The foregoing information can be used be used by the system operator, or by the client, to determine how widely the card, associated with a particular promotion, is being distributed and used, to thereby evaluate the success of the promotion, and/or to contact the user with additional offers or promotional materials.

The card can optionally instead be activated via an interactive voice response system or otherwise. Some or all of the foregoing information can be collected via the voice response system. Optionally, once the card activation information is received by the card processing system, the system can delay activating the card for a predetermined amount of time, such as by one day or one week. In addition to obtaining user information that may be useful to the card system operator or it clients, the actual use of the distributed cards may be reduced as there may be recipients that are not sufficiently motivated to provide the requested information in order to obtain card activation or that will remember to use the card after the activation delay.

Optionally, when the user registers or activates the card, the system can transmit to the user, via a Web page, email, or otherwise, addresses and/or maps of merchants within a certain distance of the user's address or zip code at which the card can be utilized. Thus, for example, the user can be informed of the 5 closest participating merchants, or of participating merchants within a five mile radius, thus making it easier for the user to find a convenient location at which the card can be used.

Optionally, if there is no participating or appropriate merchant within a selected area or distance of the user (e.g., such as 20, 30, or 50 miles), optionally, the user is provided with an alternative item of value, such as movie DVD, a musical album, a coupon usable to purchase a product, a check of a selected value, and so on. In addition or instead, the card can be authorized for use at a different merchant or merchant type that is within a certain distance of the user. For example, if card was initially authorized for use to see a movie (e.g., a movie based on a book) at a movie theater, but no theater was proximate to the user, the card can be re-authorized to be used to buy a book at a book store so as to promote the book on which the movie was based.

Optionally, the user may be presented with a list of alternative items for which the card can be authorized to purchase, or a list of merchants or merchant types at which the card can be authorized for use. Thus, for example, the user can be presented with a variety of merchant types, such as “book store”, “movie rental”, and “supermarket”. The user can select the desired merchant type, and user selection is stored in a database in association with a card identifier (e.g., the card number) and optionally in addition to user information. The ticket processing system can optionally notify a corresponding authorized processor that the card is now authorized at the selected merchant or merchant type.

Optionally, the card can also act as a coupon, with a monetary value (e.g., $4.99) printed thereon. Thus, if the applicable rules so allow, if a merchant cannot process the card (e.g., because the merchant does not accept any cards, does not have the authorized MCC, and/or does not have an authorized merchant ID) as a card, the merchant can process the card as a coupon (e.g., wherein the user can purchase an item using the card as a coupon), and then send the card into the card processing system for reimbursement (e.g., reimbursement up to the value printed thereon, or a greater or lower value).

Optionally, the cards disclosed herein can be shaped in a non-compliant manner with respect to ISO 7810, JIS (defined by Japan IC Card System Application Council) and/or AAMVA (American Association of Motor Vehicle Administrators) standards. For example, a card can be sized or shaped to be larger than a typical wallet card slot in one or more dimensions so as not to fit in such a standard credit card slot. By way of example, the card can be sized so at least one or two dimensions exceed that of the ISO standard (85.60 mm×53.98 mm×0.76 mm). For example, the card can be sized as follows: 87.00 mm×56.00 mm×0.9 mm. Optionally, the card can have one or more dimensions that are smaller than that specified by the ISO standard (e.g., the card can have a width of 0.6 mm, 0.55 mm, 0.5 mm, or a still smaller width).

By way of further example, the card can be shaped so as to resemble an item being promoted. By way of illustration, if a movie is being promoted, the card can be shaped substantially like a movie ticket in at least one, two, or three dimensions. By way of further illustration, if a DVD is being promoted, the card can be shaped as a disk or DVD. Optionally, a card magnetic stripe and/or bar code (e.g., an ISO 7811 compatible bar code) can be located, and the card dimensioned, so as to work with a standard credit card swiper. Optionally, a card magnetic stripe and/or bar code can be located, and/or the card dimensioned, so as not to work physically with a standard, ISO compatible credit card swiper. Optionally, a custom card swiper can be configured and provided that accommodates the non-standard shape of the card.

For example, the card swiper slot can be provided with a slot width of 2 mm to accommodate a card having a non-standard width of up 0.8 mm to about 2 mm. By way of further example, the slot can be sized to prevent the use of an ISO compliant card. For example, in one embodiment, the width has a dimension of about 0.6 mm, 0.55 mm, 0.50 mm or less.

Optionally, the card processing system and/or its operator can estimate and allocate a certain amount of money to cover the expected charges for a set of cards (e.g., a set of cards associated with a certain promotion) based on an expected redemption rate and expected charge-per-card that is activated and used. Optionally, insurance can be obtained from an insurance company or otherwise, to cover actual amounts over the estimated or allocated amount. Using insurance in this manner provides for greater cost predictability and controllability with respect to a promotion, incentive, or reward program that utilizes the disclosed cards.

Example embodiments will now be discussed with reference to the figures.

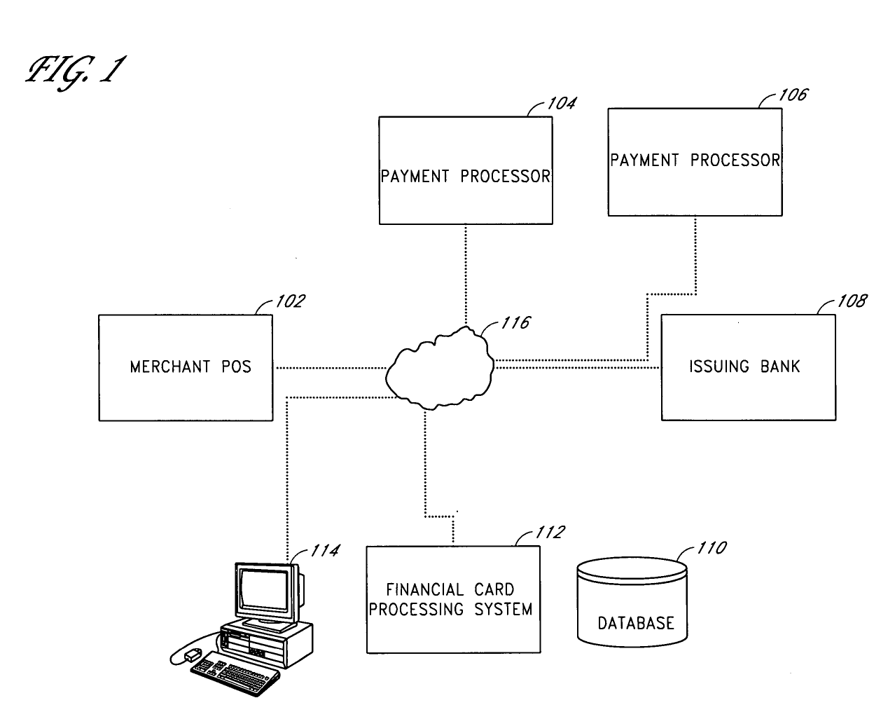

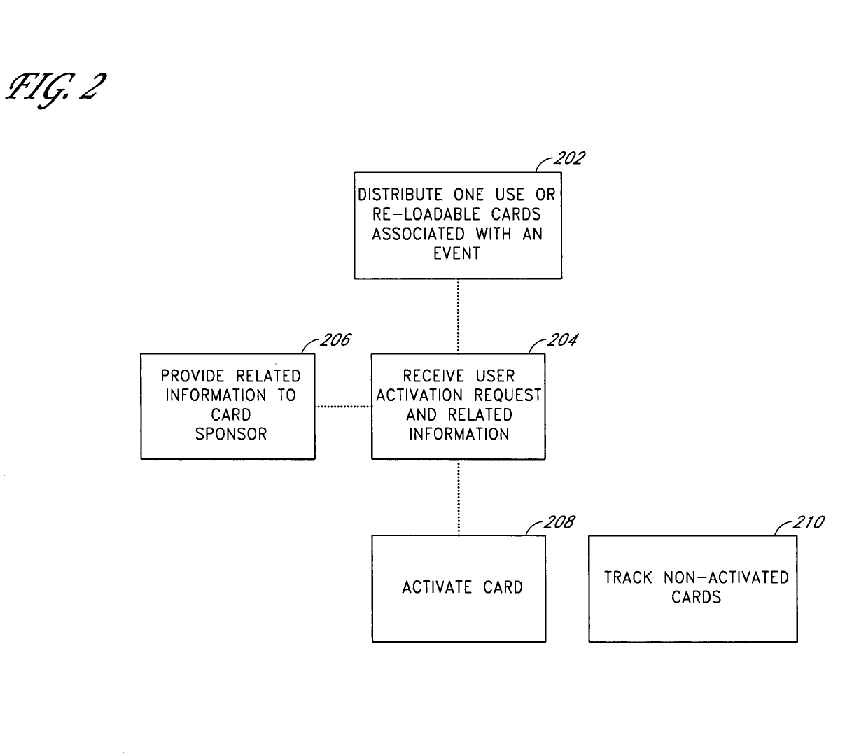

FIG. 1 illustrates an example environment. In this example, a merchant POS terminal 102 (e.g., a terminal including a card swiper), a first payment processor 104, a second payment processor 106, an issuing bank 108, a financial card processing system 112, and a user terminal 114 (e.g., a personal computer, a cell phone, an interactive television, etc.) are coupled to a network 116 (e.g., the Internet, an intranet, or other network). The example financial card processing system 112 optionally includes a database 110. For example, the database can store user information, results of brand surveys, and card information. The user information optionally includes user demographic information, as discussed elsewhere herein, contact information, information regarding when the user activated the card, as well as other information. The card information can include, for each card in a set of cards, unique identification information (e.g., a card number) associated with the card, how the card was or will be distributed (e.g., by being packaged with a product, mailed, dispensed by a human, dispensed by an electronic dispenser machine, etc.), whether the card has been registered by a user (e.g., by a user providing the card number and/or other requested information over a network or otherwise), the card type (e.g., a one-use card, a re-loadable card, a multiuse card, etc.), the maximum card value, the card expiration date, whether further card use has been disabled, a card sponsor identifier, an identifier related to the event or product being promoted via the card (if applicable), an identification of the merchants or merchant types at which the card can be used (e.g., via merchant identifiers and/or MCC codes), an identification of the product or product type authorized for purchase using the card, and whether the card has been used. If the card has been used in a transaction, the database 110 can further store the transaction amount, the date and time of the transaction, and identification information regarding the merchant with which the transaction was conducted.

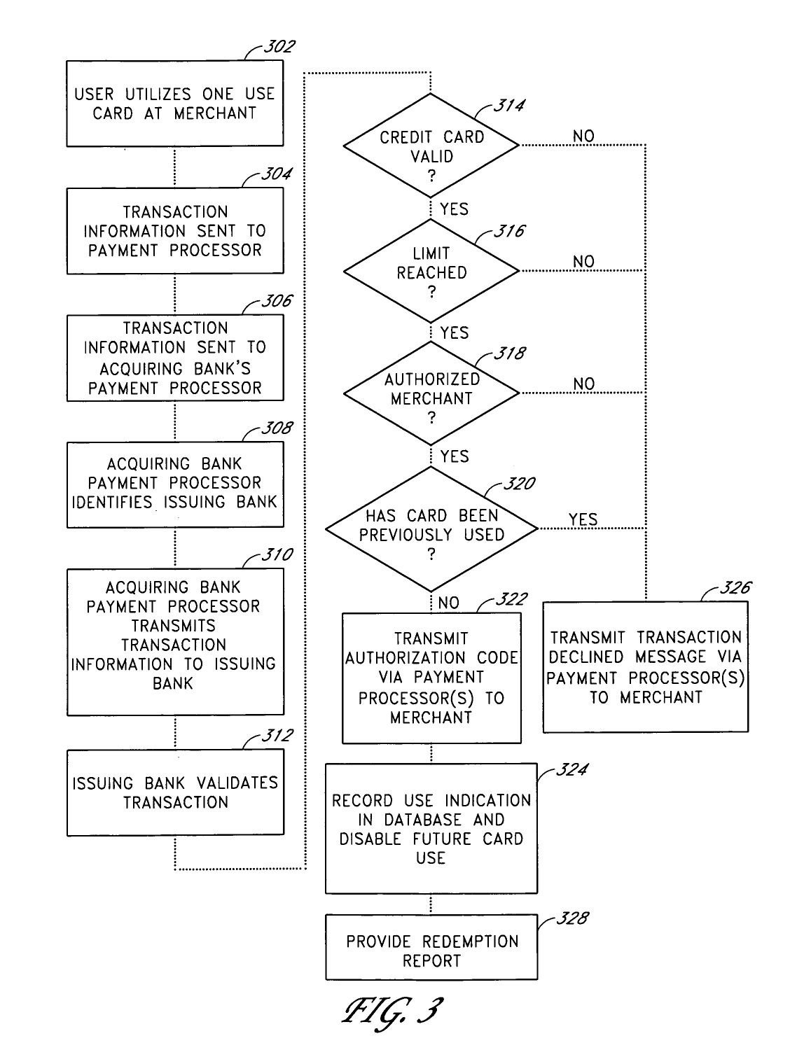

An example distribution process for one-use or re-loadable cards will now be described with reference to FIG. 2. At state 202, a set of one-use or re-loadable cards associated with an event is distributed. By way of example, the event can be a movie or other product promotion, a customer reward event, an employee incentive event, or other event. The cards can be issued on behalf of a card sponsor: that is paying for purchases, or a portion thereof, made via the cards; that is using the cards to promote a service or product associated with the card sponsor; and/or that is using the cards to reward or incentivize the card sponsor's customers or employees.

As previously discussed, the cards can be issued with a zero initial value, or otherwise not activated. In addition, the cards optionally do not have a user/card recipient (e.g., a card holder/end user) name printed or encoded thereon. The cards can optionally be distributed by being packaged with a product, by a human at a retail store, via an electromechanical card dispenser, or otherwise.

At state 204, a card recipient accesses a card processing system user interface, such as a form accessed via a Web page, and provides requested information in order to activate the card. For example, the information can include contact and demographic information regarding the card recipient, demographic information regarding the recipient's household, and information regarding a brand associated with the card sponsor (e.g., a brand being promoted via the card). The received information is then stored in a card processing system database, such as database 110 discussed above.

At state 206, some or all of the information received from the card recipient is retrieved from the database and transmitted to, or otherwise provided to the card sponsor. Some or all of the information can be processed, summarized, and/or aggregated with information related to other card recipients prior to providing the information to the card sponsor. The card sponsor can use the information to evaluate whether the cards are being activated or utilized by a desired target audience (e.g., users of a certain age, gender, income, or having other desired characteristics), and/or to modify the sponsor's promotional, reward, or incentive events.

At state 208, the card recipient's card is activated as similarly elsewhere described herein. The card has a predetermined spending limit set. For example, as described herein, the predetermined limit can be set to be sufficient to cover an estimated price of a movie ticket, or other item being promoted. Optionally, the card can be limited to one-use. The card recipient can be informed of the spending limit, the intended use of the card, that the card can only be used once, the expiration date of the card, if any, and other related information via a Web page hosted by the card processing system, printed material, information printed on the card itself, and/or otherwise.

At state 210, the number of activated and/or unactivated cards in the set of cards is optionally continuously tracked. This information can be used to predict or estimate the total number cards that will be activated by the time the associated expiration date, and so how much funds will be needed to fund purchases made using the issued set of cards.

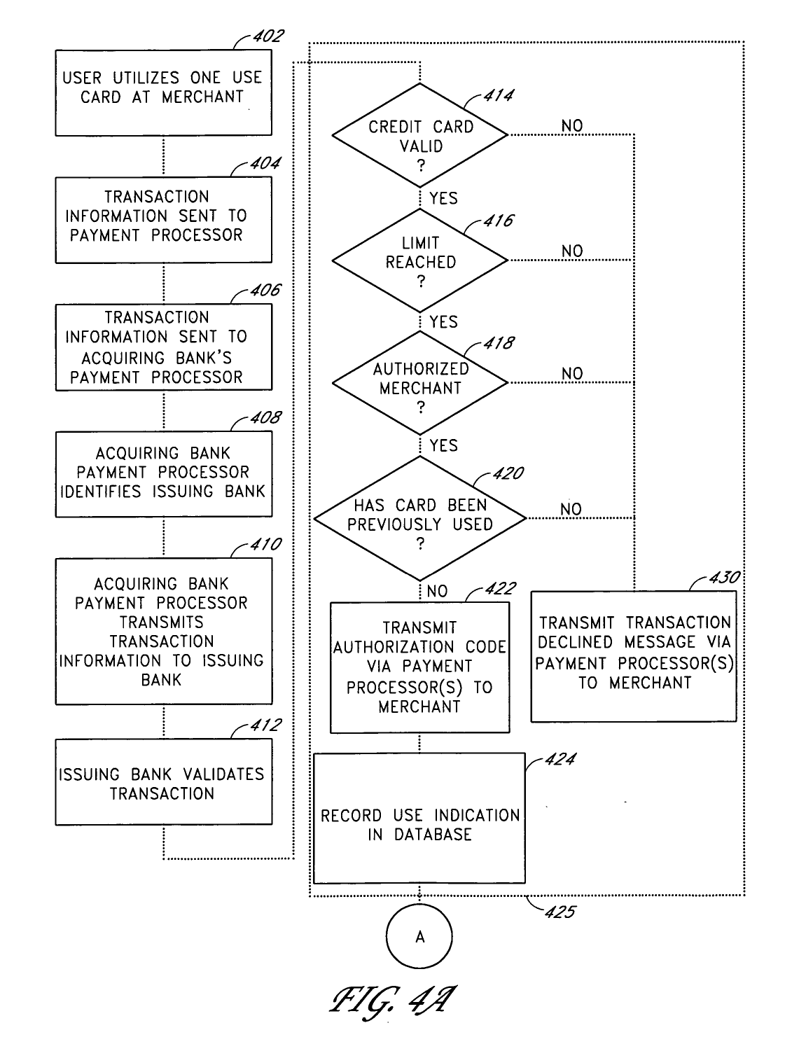

FIG. 3 illustrates a flow chart illustrating an example limited use financial card transaction process. At state 302, a user utilizes a limited use card (e.g., a one-use card) at a merchant. For example, the merchant may swipe the card via a point of sale (POS) terminal card swiper. The POS terminal card swiper reads information recorded on a magnetic stripe affixed to the card and/or optically reads information from a financial card bar code, such as a card number identifier. At state 304, some or all of the information read from the financial card (e.g., a country code; the name of the system operator, the card sponsor, and/or a promotional campaign name; an expiration date; discretionary data; and/or an account number associated with the system operator, a sponsor, and/or other appropriate entity), and/or other transaction information (e.g., the merchant MCC, merchant ID, transaction amount) is transmitted by the POS terminal to a payment processor. In this example, the payment processor manages the process of transferring authorized financial card funds between different financial accounts.

At state 306, some or all of the foregoing information is transmitted to the acquiring bank payment processor. By way of example, the acquiring bank approves a merchant for accepting financial cards, and then collects the merchant's online payments. By way of further example, an acquiring bank can be a member of Visa and/or MasterCard Associations. At state 308, the acquiring bank payment processor identifies the card's issuing bank. At state 310, the acquiring bank payment processor transmits some or all of the above transaction information to the issuing bank.

At states 312, 314, 316, 318, and 320, the issuing bank correspondingly validates the transaction, determines if the financial card is valid, whether the credit or other amount limit has been reached, whether the merchant is an authorized merchant for this transaction (e.g., by determining if the merchant is in an authorized category of merchant's by comparing the merchant's MCC with that of the designated authorized MCC(s), or by determining if the merchant ID matches an authorized merchant ID), or if the card is a one-use card that has previously been used. If the system determines that one or more of the foregoing conditions are not met, the process proceeds to state 328, and a transaction declined message is transmitted to the merchant via one or more payment processors. If, instead, the foregoing conditions are met, an authorization code is transmitted, via one or more payment processors, to the merchant, and the transaction with the user can be completed.

At state 324, the card processing system records in the card processing system database, in association with the card number or other card identifier, an indication that the card has been used in a transaction. The future use of the card is disabled (e.g., the card is deactivated or its value is set to zero) so that further purchases will not be made using the card as a payment vehicle. At state 328, one or more card use or redemption reports are generated by the card processing system and optionally transmitted to the card sponsor. For example, the sponsor can be informed whenever a sponsored card has been used, the sponsor can be periodically informed (e.g., once a day) how many cards have been used in a selected time period, and/or the sponsor can be informed how many cards have been used once all the cards in the set of cards have expired or have been disabled (e.g., at the end of a predetermined promotion period). The sponsor can further be informed what the items or services the cards have been used to purchase.

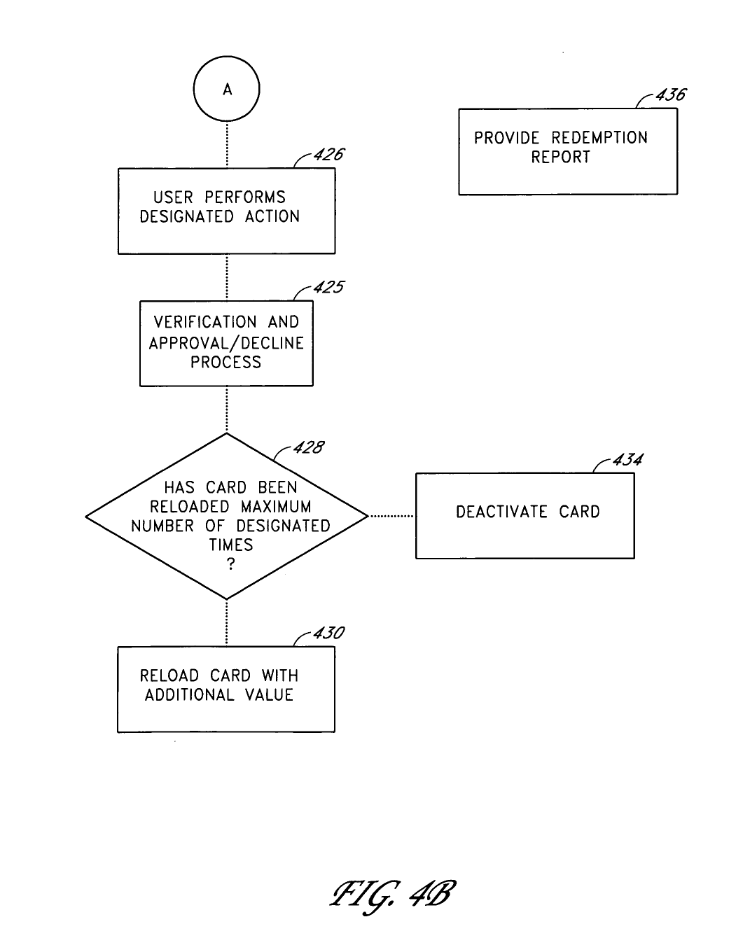

FIG. 4 illustrates a flow chart illustrating an example re-loadable financial card transaction process. As will be described, optionally, in response to a card holder action the card may be loaded with additional value after it has been used. Optionally, the number of times the card can be re-loaded with value is limited to a predetermined number of times. For example, in response to a card sponsor instruction, the card processing system operator can record in a database a value indicative of the number of times the card can be re-loaded with value. This value can be retrieved and compared against the number of times the card has been reloaded and/or used (which value can also be stored in, and retrieved from the database) to determine whether the card is to be reloaded with value.

With reference to FIG. 4, at state 402, a user utilizes a re-loadable at a merchant. For example, the merchant may swipe the card via a point of sale (POS) terminal card swiper. The POS terminal card swiper reads information recorded on a magnetic stripe affixed to the card and/or optically reads information from a financial card bar code, such as a card number identifier. At state 404, some or all of the information read from the financial card (e.g., a country code; the name of the system operator, the card sponsor, and/or a promotional campaign name; an expiration date; discretionary data; and/or an account number associated with the system operator, a sponsor, and/or other appropriate entity), and/or other transaction information (e.g., the merchant MCC, merchant ID, transaction amount) is transmitted by the POS terminal to a payment processor. In this example, the payment processor manages the process of transferring authorized financial card funds between different financial accounts.

At state 406, some or all of the foregoing information is transmitted to the acquiring bank payment processor. By way of example, the acquiring bank approves a merchant for accepting financial cards, and then collects the merchant's online payments. By way of further example, an acquiring bank can be a member of Visa and/or MasterCard Associations. At state 408, the acquiring bank payment processor identifies the card's issuing bank. At state 410, the acquiring bank payment processor transmits some or all of the above transaction information to the issuing bank.

At states 412, 414, 416, 418, and 420, the issuing bank correspondingly validates the transaction, determines if the financial card is valid, whether the credit or other amount limit has been reached, and whether the merchant is an authorized merchant for this transaction (e.g., by determining if the merchant is in an authorized category of merchant's by comparing the merchant's MCC with that of the designated authorized MCC(s), or by determining if the merchant ID matches an authorized merchant ID). If the system determines that one or more of the foregoing conditions are not met, the process proceeds to state 430, and a transaction declined message is transmitted to the merchant via one or more payment processors. If, instead, the foregoing conditions are met, an authorization code is transmitted, via one or more payment processors, to the merchant, and the transaction with the user can be completed.

At state 424, the card processing system records in the card processing system database, in association with the card number or other card identifier, an indication that the card has been used in a transaction. Optionally, the future use of the card is disabled (e.g., the card is deactivated or its value is set to zero) so that further purchases will not be made using the card unless additional value is added to the card. At state 426, the user performs a designated action which entitles the user to have additional value to the card so that the card can be used again. For example, the designated action can be related to the purchase of a designated product or service associated with the card sponsor. The process proceeds to state 425, and the verification and approval process discussed above is performed. At state 428, the card processing system retrieves from the system database information indicating how many times the card has been re-loaded with value, and how many re-loads are permitted for the card.

If the card has not yet been loaded the permitted maximum number of times, then, at state 430, the card is reloaded in accordance with reload instructions stored in, and retrieved from computer readable memory (e.g., reloaded with enough value to purchase a movie ticket, a DVD, a restaurant meal, or other designated product or service). If the card has been reloaded the maximum permitted number of times, the card is disabled so that it will not be approved for use in another transaction.

At state 436, one or more card use or redemption reports are generated by the card processing system and optionally transmitted to the card sponsor. For example, the sponsor can be informed whenever a sponsored card has been used, the sponsor can be periodically informed (e.g., once a day) how many cards have been used in a selected time period, the number of times cards have been reloaded with value, what the items or services the cards have been used to purchase, and/or the sponsor can be informed how many cards have been used once all the cards in the set of cards have expired or have been disabled (e.g., at the end of a predetermined promotion period).

The settlement process, wherein the merchant is paid for the financial card transaction, can be a conventional or unconventional settlement process whether a one-use or multiuse card is used in a transaction.

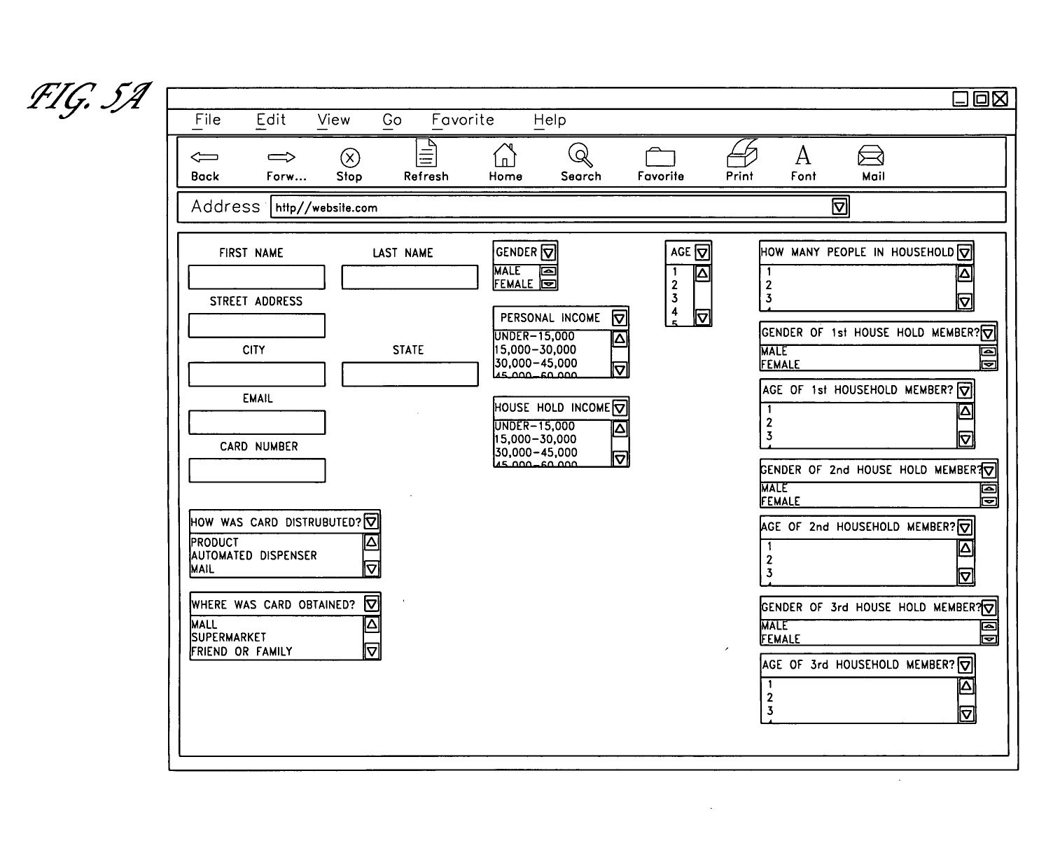

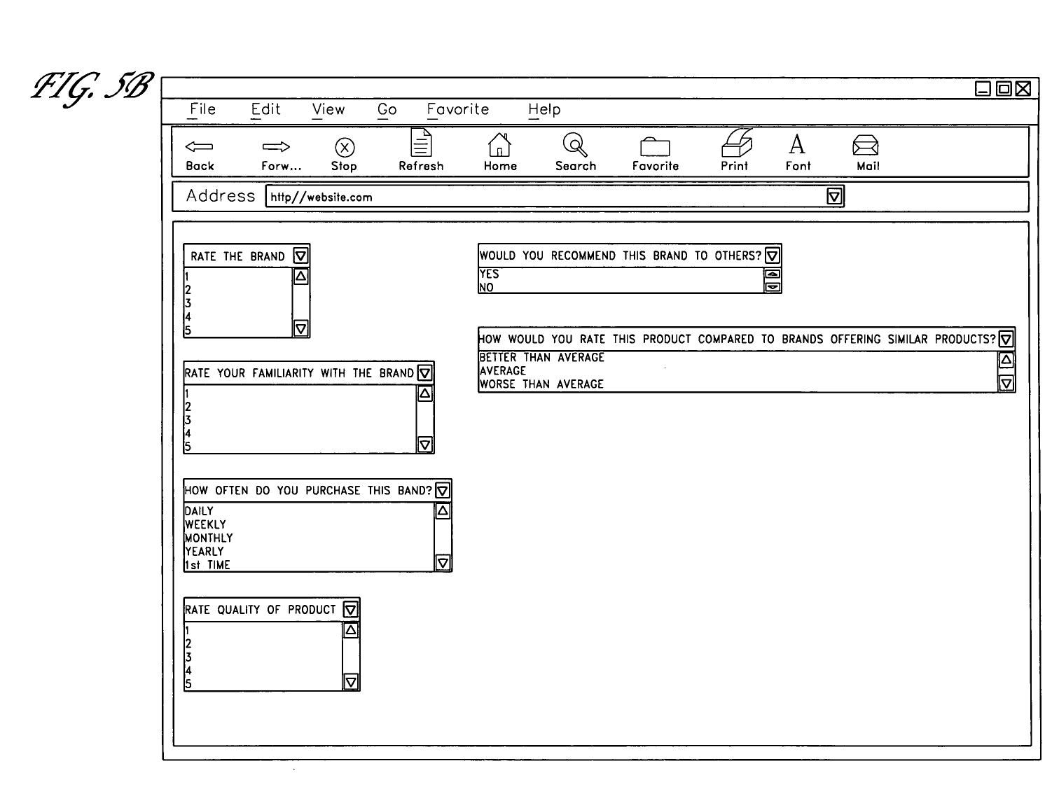

FIGS. 5A-B illustrate example user interfaces which request information from a card holder in order to activate the card holder's card and/or to collect information, some or all of which can be provided to a card sponsor. The user interface can be hosted by the card processing system and transmitted over a network (e.g., the Internet, an intranet, a cable network, or other network) to a card holder terminal as a Web page. FIG. 5A includes the following fields, although fewer, more, or different fields can be provides as well:
name fields;
contact information fields (e.g., address, email address, phone, fax number);
demographics fields (gender, age, personal income, household income, number of people in the card holder's household, their genders, ages);
card-related fields (fields via which the card holder can enter a number or other identifier printed on the card, where the card holder obtained the card, how the card holder obtained the card).
FIG. 5B includes the following brand survey fields, although fewer, more; or different fields can be provides as well:
a field via which the card holder can provide his or her opinion regarding one or more brands;
a field via which the card holder can provide information regarding the card holder's familiarity with the brand;
a field via which the card holder can provide information regarding how often the card holder purchases an item associated with the brand;
a field via which the card holder can provide information regarding the card holder's opinion regarding the quality of products or services associated with the brand;
a field via which the card holder can indicate whether the card holder would recommend the brand;
a field via which the card holder can provide information regarding the card holder's opinion on how the brand compares with other brands in the same field.

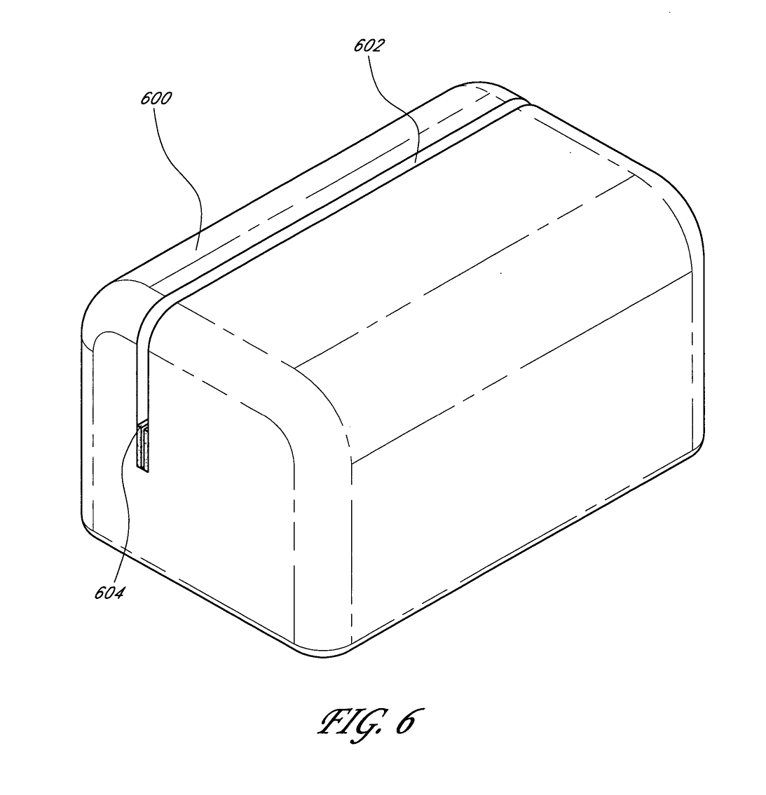

FIG. 6 illustrates an example card swiper configured not to accept an ISO standard card. The swiper 600 has a slot 602 via which the card is to be swiped through. In one embodiment, the slot 602 has a width of 0.65 mm (which is to narrow to accept an ISO card having a width of 0.76 mm), and a magnetic stripe reader 604 is positioned to read a magnetic stripe about 1 centimeter from the edge of the card (as opposed to 0.56642 centimeters from the edge of the card in accordance with ISO standards). Optionally, the magnetic stripe reader is configured to read data encoded on the stripe in a non-ISO compliant manner.

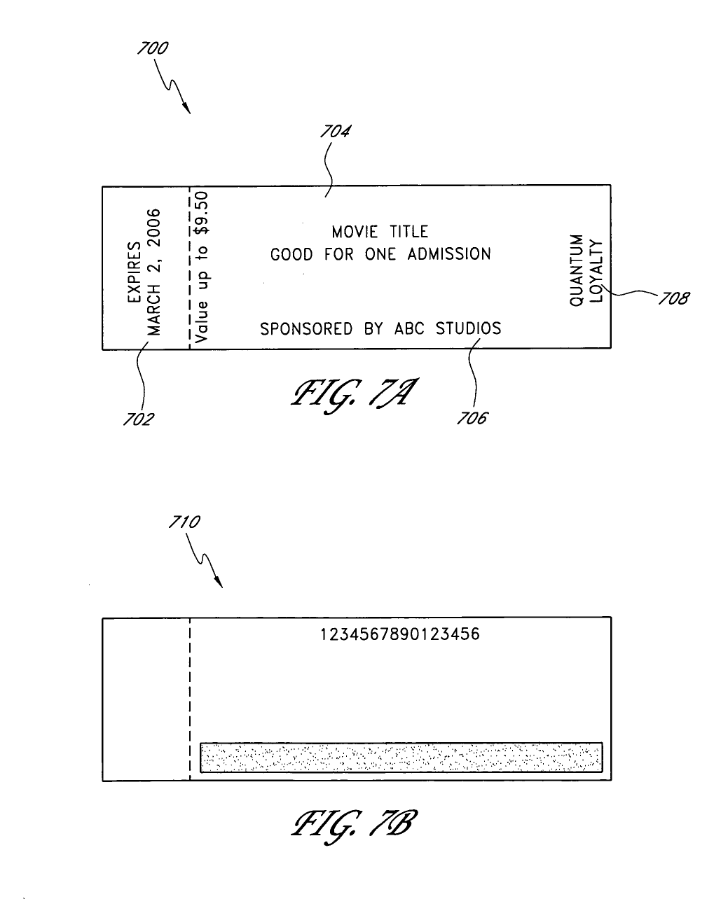

FIGS. 7A-B illustrates an example financial card 700 configured to a have the appearance, dimensions and/or proportions similar to a movie ticket. For example, the illustrated card 700 can have a length of about 12 cm, a width of about 3.8 cm, and a thickness of about 0.6 mm. The example card 700 has an area 704 wherein the intended use is printed thereon (e.g., the name of a movie being promoted for which the card can be used to purchase a ticket). The card can also have an indication that the card is good for one (or other designated number) admission to a movie. In addition, the example card 700 has an area 710 wherein the maximum card value is printed thereon (e.g., $9.50). An area 702 is further provided in which the card expiration date (e.g., Mar. 2, 2006) is printed thereon. An area 706 is provided in which the card sponsor's name and/or logo is printed thereon (e.g., ABC Studios) is printed thereon. An area 708 is further provided in which the card processing system operator (e.g., Quantum Loyalty®) is printed thereon. FIG. 7B illustrates the backside of the card 700, having a magnetic strip 710 affixed thereon. The card 700 can be manufactured from plastic or other material. Optionally, the card can further include a hologram or other fraud prevention device.

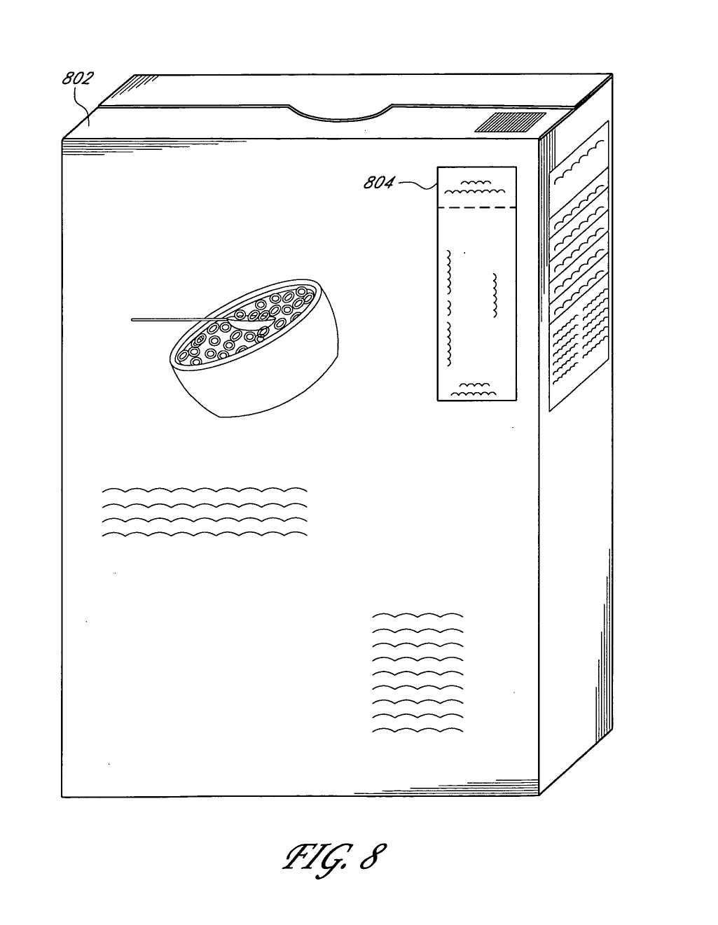

FIG. 8 illustrates an example product package (e.g., a cereal box) 802 having a financial card 804 affixed thereon (e.g., affixed via adhesive, via a clear cover or wrapping, such as a polyvinylidene wrap or a shrink wrap). As discussed above, the financial card 804 can optionally be packaged in the package 802, rather than affixed to the outside of the box.

Thus, as described herein certain example embodiments provide for the distribution of a financial instrument without requiring a credit check or a bank account for the end user and without knowing the identity of the end user. The financial cards can be one-use cards, multiuse cards, or reloadable cards. The cards can optionally be distributed with a zero initial value. The cards can optionally be distributed with consumer products. The cards optionally are non-ISO compatible and can physically resemble something other than a credit or debit card. A card reader is described which can be used to swipe and read the non-ISO compatible card.

An example embodiment provides a prepaid, low material cost certificate (e.g., paper or electronic) integrated with a credit/debit card network. The example Prepaid Low Cost Certificate (PLCC) described herein enables a consumer to make a purchase using a financial network (e.g., a national or international card/debit network) without requiring the use of a relatively expensive plastic card (e.g., a plastic debit card). For example, the PLCC can be paper. Account numbers/codes and related data of a card/debit network (e.g., a national or international card/debit network) are received from a third party card processor and stored in a secure database. The consumer receives a unique authorization number or other code or identifier (e.g., from product/food packaging, a bottle top, a coupon, etc.) that makes the user eligible to receive something of value (e.g., a free promotional reward, such as a movie ticket, a book, a CD, a DVD, downloadable music/movies, food items, clothing, etc.) from a third party. The consumer enters the unique authorization number (or other identifier) into a form (e.g., a Web page form hosted on a website), and optionally enters personal information such as name, address, email address, SMS address, mobile phone number, landline number, etc.

One or more databases are searched/queried to confirm the validity of the unique number or identifier and to optionally identify participating retailers or service providers within a certain geographic area of the consumer (e.g., within a user and/or operator specified distance of the user's address, or within the same zip code as the user's address). A debit card account number (e.g., from a national/international credit/debit card network) is optionally generated substantially instantaneously and/or is retrieved from a database. Optionally, related information is generated substantially instantaneously and/or is retrieved from a database. The account number and other related information is integrated into the PLCC and transmitted, optionally substantially instantaneously to the consumer (e.g., over the Internet, via an email, a Web page, an SMS message, etc.).

For example, an email with a link to a downloadable file, such as a PDF (Portable Document Format) file accessible over the Internet, can be transmitted to the user. The consumer activates the link, and the consumer's browser or other download software downloads the file to the consumer's terminal (e.g., personal computer, interactive networked television, smart phone, personal digital assistant, networked video game terminal, etc.). The file is presented on the terminal display via viewing software (e.g., Adobe Acrobat Reader). The consumer prints, via a printer, the file (e.g., the PDF file) which contains the PLCC. The PLCC is optionally in the form of a barcode or other computer readable/scannable indicia. Additionally, the debit card account number and other pertinent information (CVC2 or AVS security information) are optionally distributed using other distribution channels, such as via a phone network (e.g., a WiFi/VoIP or cellular phone network, wherein indicia corresponding to a PLCC is transmitted to, and displayed on a wireless phone display system). The PLCC, when printed or displayed on a terminal display, can be the same or similar in appearance to the example card illustrated in FIG. 7A and/or FIG. 7B.

The consumer presents the printed PLCC to a retailer, service provider, or other entity, who enters (e.g., manually via a keyboard or using a barcode scanner) the account number and related data, which is transmitted to an entity associated with a credit/debit card network. The retailer, service provider, or other entity provides the good or service to the consumer. The account information is processed by a credit/debit card network entity, which results in the retailer or service provider receiving payment from a funding entity (e.g., a sponsor of the PLCC or an entity acting on behalf of the sponsor, wherein, for example, the sponsor is attempting to gain publicity or otherwise gain customers for a movie, a book, clothing, a service, etc.).

If there is a not a participating retailer or service provider that accepts the credit/debit card network's card within the designated geographic area, the consumer is directed to a participating retailer, service provider, or other entity that attaches to the PLCC a checking account number (e.g., in encrypted/encoded or in unencrypted/uncoded from). For example, the retailer, service provider, or other entity receives a pre-printed MICR encoded checking account number (e.g., wherein the MICR is printed on a media, such as paper, optionally with adhesive on one side, and attaches the MICR to the PLCC using the adhesive, a stapler, or other attachment mechanism), debit card account number, or other account number. As is well known, MICR (Magnetic Ink Character Recognition) is a character recognition system that uses characters formed using an ink that can be magnetized. In order to read the MICR characters, the MICR encoded document is passed through a MICR reader which magnetizes the ink and then translates the magnetic information into characters. Other optical and/or magnetic indicia can be used instead of or in addition to the MICR characters. The participating retailer or service provider deposits the PLCC with their bank, which processes it through a check clearing system and receives payment from the funding source.

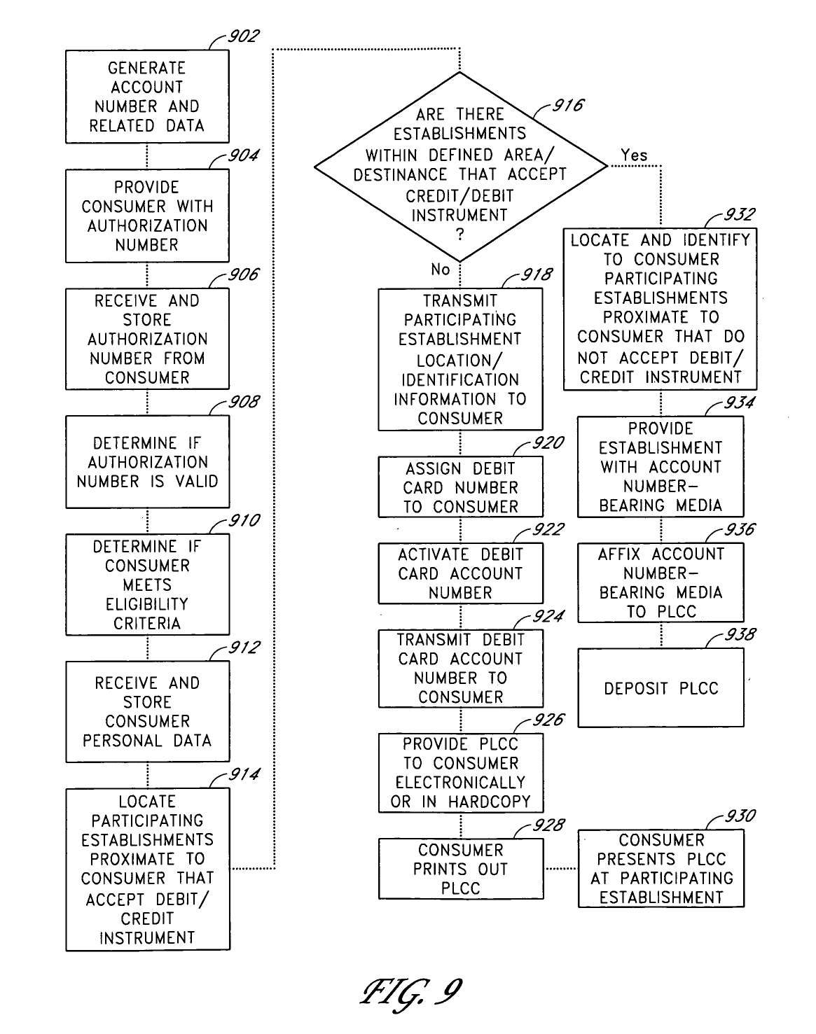

FIG. 9 illustrates an example process of utilizing and distributing a PLCC. In this example, account numbers and related data of a financial network (e.g., a national credit/debit card network) are generated at state 902 by one or more a third party card/certificate processors and transmitted (e.g., securely, such as via SFTP (Secure File Transfer Protocol) using PGP (Pretty Good Privacy) data encryption). The related data optionally includes corresponding expiration dates, and security codes (including CVC2 and AVS information). The account numbers/codes and expiration dates are transmitted separately from the security code data. The account numbers/codes and security codes are received, matched and stored in a secure database. By way of example, the database can be hosted and managed by a sponsor of the PLCC, an entity acting on behalf of the sponsor, or another entity.

At state 904, the consumer receives one or more unique authorization numbers (the term “authorization number” or “code” can include identifiers that include non-numeric identifiers, such as alphabetical characters, symbols, or icons). The authorization number/code can be generated by a third party or by the provider of the PLCC. The authorization number(s) can be provided before, with, or after, the purchase of a product or service. For example, the authorization number/code can be printed on a bottle top, a product label, a coupon, a receipt, or on other media. The authorization number can also be a pre-existing membership number, such as a frequent flyer account number. The authorization number can be of variable length or format.

At state 906, the consumer enters the authorization number/code (e.g., using a terminal to access a user interface hosted by a website, and entering the authorization number into a corresponding authorization number field) and the authorization number/code is stored in computer readable memory, such as in a database (e.g., a database hosted by the financial card processing system 112). Optionally, such authorization numbers/codes can only be used a single time or a single time within a specified time period. Optionally, CAPTCHA (Completely Automated Public Turing Test to Tell Computers and Humans Apart) Validation is used to ensure that the site is being accessed by a human and not a software script (e.g., a malicious, automated computer script).

At state 908, software executing on a computer system (e.g., the financial card processing system) queries the database and determines if the authorization number/code is valid (e.g., has the proper number of characters in the allowable ranges, has not been previously used, has not been previously used within a specified time period, etc.), and optionally for which promotion (e.g., a promotion for a book, movie, sound recording, software, electronics, food, household supplies, telephone service, etc.) it is associated with. At state 910, the software can also perform determinations/calculations to determine if the consumer is eligible to receive and/or utilize a PLCC. By way of example, the software can access one or more eligibility rules stored in memory (e.g., a database) and determine if the consumer has met those rules before authorizing a PLCC for the consumer.

For example, a rule can specify that the user needs to have made a purchase of a certain dollar amount and/or purchased a certain quantity of an item within a specified time period (e.g., within a period defined by a start date and a stop date) in order to be eligible to receive a corresponding PLCC. By way of illustration, a rule can specify that at least a specified number of authorization codes be submitted (e.g., 5 proof of purchases or 5 authorization codes from 5 item packages) and/or that reasonable proof be submitted that at least a certain dollar value of one or more specified items were purchased (UPC (Universal Product Code) codes representing or corresponding to $50 of purchases). In this example, the consumer has met the eligibility rules and the authorization code is determined to be valid.

In this example, at state 912, the consumer enters personal data (e.g., into a form hosted by the website), such as name, address, email address, SMS address, mobile phone number, landline number, or contact information, etc. Optionally, the same or similar personal data can be gathered via a survey (e.g., a marketing survey) or other information gathering technique.

At state 916, a database is queried by the software to identify participating retailers or service providers that accept the cards of the national credit/debit card network within a certain geographic/governmentally defined area (e.g., within a specified distance from the consumer or within the same zip code of the consumer) of the consumer. At state 918, a determination is made whether there are participating retailers or service providers that accept the cards of the national credit/debit card network within the certain geographic area of the consumer.

If there are no participating retailers or service providers that accept the cards of the national credit/debit card network within the certain geographic area of the consumer (e.g., within a certain number of miles, specified by the consumer and/or an entity involved in providing the authorization number/code), the consumer is automatically directed by the software to a different set/list of participating retailers or service providers and follows a different process, as discussed below with respect to states 932-938.

If there are participating retailers or service providers that accept the cards of the national credit/debit card network within the certain geographic area of the consumer, the process proceeds from state 916 to state 918. At state 918, the system transmits information (e.g., name, address, distance from consumer, directions) regarding participating retailers or service providers that accept the cards of the national credit/debit card network within the certain geographic area. For example, the information can be provided to the consumer via a Web page displayed on a terminal associated with the consumer.

At state 920, a debit card/instrument account number/code from a credit/debit card network is generated/accessed by the software from the database along with other related information, and assigned to the consumer. At state 922, data is transmitted (e.g., securely, such as via SOAP (Simple Object Access Protocol)) by the software over a network to a card processor (e.g., a third party card process) in order to activate the debit card/instrument account number/code so that debit card/instrument account number/code can be used in the credit/debit card network, and to input information (e.g., the personal information discussed above) about the consumer into the card processor system, where it is stored in a database in association with the authorization number/code.

At state 924, the debit card/instrument account number/code and other related information including, by way of example, the debit card/instrument expiration date, security code, the consumer's street address, zip code, and/or consumer's name, are integrated (e.g., printed on/electronically embedded in encrypted or unencrypted form, in human readable and/or machine readable form) by software executing on a computer system into a PLCC or distributed to the consumer via a cellular or VoIP phone/network (e.g., in the form of a code displayable on the phone display).

The debit card/instrument account number/code and related information is optionally printed on to the PLCC, such as, by way of example, in the form of a bar code which can be read by a scanning device. The PLCC or the PLCC activation website optionally also contains (e.g., has printed/displayed thereon) information about the good or service that the consumer can receive, optionally including terms, conditions, procedures and/or promotional information.

At state 926, the PLCC is sent to the consumer by mail or electronically (e.g., via email with a link to download a PDF or other printable file). If the PLCC is sent to the consumer electronically (e.g., as a PDF file), at state 928, the consumer prints the file which contains the electronic representation of the PLCC using a computer and associated printer (or, if the PLCC is distributed via a wireless phone system, goes to a retailer or service provider, per state 930 below).

At state 930, the consumer presents the PLCC to a participating retailer or service provider who enters the debit card/instrument account number/code and related data into a credit/debit card network (e.g., by scanning the PLCC or by manually typing in the PLCC authorization number/code), and the information is transmitted via a terminal (e.g., a point of sale terminal) associated with the retailer or service provider) to an entity associated with the credit/debit card network. The transaction is then processed by the credit/debit card network. If the debit card/instrument account number/code is approved, the retailer or service provider then provides the consumer with the good or service described on or accessed via the PLCC, and receives payment through the credit/debit card network.

If there is a not a participating retailer or service provider that accepts the credit/debit card network's card within the specified geographic area, the process proceeds from state 918 to state 932. A database (e.g., the database discussed above, hosted and managed by a sponsor of the PLCC, an entity acting on behalf of the sponsor, or another entity) is optionally searched or queried to find a participating retailer or service provider that does not accept the national credit/debit card network's card. A list of such retailers or service providers who are within a certain geographic area of the consumer are transmitted to the consumer (e.g., over a network via a Web page, an email, or otherwise).

At state 934, the participating retailer or service provider is provided with checking account-bearing media, such as a stock of pre-printed adhesive forms that contains a checking account number/code in Magnetic Ink Character Recognition (MICR) format.

At state 936, the consumer presents the PLCC to the participating retailer or service provider who writes/prints/stores or otherwise affixes the amount of the product or service on the PLCC and attaches the pre-printed MICR encoded checking account number/code to the PLCC media. At state 938, the participating retailer or service provider deposits the PLCC with their bank who processes it through the check clearing system and receives payment.

Optionally, instead of or in addition to printing certificates with a prepaid debit card/instrument or checking account number/code using MICR, a certificate can be printed with a non-MICR bank account routing number/code (e.g., a human readable checking account number/code, such as one printed using numeric or alpha numeric characters). The certificate is then presented by a bearer at an establishment (e.g., a theater, supermarket, book store, etc.). The establishment can then process the certificate as they would a check. When the certificate is presented at the bank, the bank's MICR machine readers will not be able to be read and so the certificate will be rejected by the machine reader, possibly resulting in the certificate being hand processed. If the bank has an automated optical recognition device, then optionally, the bank will automatically process the certificate via such optical recognition device.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A card dispensing apparatus, comprising:
a product package that contains food, a cleaning product, an electronic entertainment device, and/or media storing a movie or music; and
a debit card or a credit card having a magnetic stripe, wherein the card is removably positioned in the product package and/or removably coupled to the product package.

2. The card dispensing apparatus as defined in claim 1, wherein the card is removable attached to the product package using adhesive.

3. The card dispensing apparatus as defined in claim 1, wherein the product package is a cardboard box and/or includes plastic.

4. The card dispensing apparatus as defined in claim 1, wherein the product package includes shrink wrapping.

5. The card dispensing apparatus as defined in claim 1, wherein the card further includes a bar code.

6. The card dispensing apparatus as defined in claim 1, wherein the card is has a unique card number thereon.

7. The card dispensing apparatus as defined in claim 1, wherein the product is a food item or a cleaning product.

8. The card dispensing apparatus as defined in claim 1, wherein the card has a first image printed thereon, and the product package has a second image printed thereon, the first image and the second image related to a first movie.

9. The card dispensing apparatus as defined in claim 1, wherein the card has a movie identifier printed thereon.

10. The card dispensing apparatus as defined in claim 1, wherein the card has information printed thereon that the card is intended to be used to purchase admission to a movie.

11. The card dispensing apparatus as defined in claim 1, wherein the card has at least one physical dimension that is not ISO 7810 compliant, and wherein the card is ISO 7811 compliant.

12. The card dispensing apparatus as defined in claim 1, wherein the product is positioned on a retail store product shelf.

13. The card dispensing apparatus as defined in claim 1, wherein the card is authorized for use at merchants having a Merchant Category Code specified by a first entity.

14. The card dispensing apparatus as defined in claim 1, wherein the card has a card value printed thereon.

15. The card dispensing apparatus as defined in claim 1, wherein the card does not have an end user name printed thereon.

16. The card dispensing apparatus as defined in claim 1, wherein the card is a debit card.

17. The card dispensing apparatus as defined in claim 1, wherein the card is a credit card.

18. The card dispensing apparatus as defined in claim 1, wherein the card is not authorized for use in making a purchase until after an end user provides requested information over a network via an electronic form.

19. A card tracking system, comprising:
at least a first data store configured to store:
a card identifier for a first debit or credit card;
at least a first merchant identifier that indicates at which merchants and/or merchants categories the first card is authorized for use at;
a value amount associated with the first card;
wherein the data store does not include information identifying a card recipient prior distribution of the financial card to the recipient, and stores information that identifies the card recipient using information received from the recipient after distribution of the financial card to the recipient; and
an interface configured to receive user identification information, first card identification information, and information related to a brand provided by the first user after the first user receives the first card.

20. The card tracking system as defined in claim 19, a card reader having a slot for receiving the first card, wherein the slot is configured to prevent an ISO 7810 compliant card from being swiped therein.

21. The card tracking system as defined in claim 19, wherein the data store stores an indication that the first card can only be used for one financial transaction by an end user.

22. The card tracking system as defined in claim 19, wherein the data store stores an indication that the first card can only be used for a specified number of financial transactions by an end user.

23. The card tracking system as defined in claim 19, wherein the data store stores an identifier related to an escrow account used to pay for transaction made using the first card, wherein the escrow account is not controlled by an end user of the first card.

24. The card tracking system as defined in claim 19, wherein the data store stores an indication that the first card can only be used for a specified number of financial transactions by an end user.

25. The card tracking system as defined in claim 19, wherein the first merchant identifier identifies movie theaters.

26. The card tracking system as defined in claim 19, wherein the data store stores an identifier related to an identity of a first entity that is funding a transaction made using the first card, wherein the first entity is funding the transaction to promote a movie.

27. The card tracking system as defined in claim 19, wherein the data store stores an indication that the first card is distributed by being included with a consumer product, wherein the consumer product is intended to be sold by a merchant.

28. The card tracking system as defined in claim 19, wherein the data store stores an indication that the first card is distributed by mail or by an electronic dispensing device.

29. The card tracking system as defined in claim 19, wherein the user identifier includes a name, an address, and/or an email address.

30. The card tracking system as defined in claim 19, further comprising code configured to prevent the first card from making purchases after the first card is used to purchase a good or service of any value.

31. The card tracking system as defined in claim 19, wherein the first card is a debit card.

32. The card tracking system as defined in claim 19, further comprising code configured to cause a user interface to be presented to a user on a terminal, the user interface including a field configured to receive information related the user familiarity with a brand associated with a product or service being promoted by an entity funding use of the first card, and a field configured to receive information related to user's opinion regarding products or services associated with the brand.

33. A method of distributing a debit card:
causing a first debit or credit card to be distributed via product packaging, mail, or a dispensing machine, wherein the first card does not have an end user name printed thereon;
storing a use indication indicating how many times the first card can be used to make purchases before the first card is disabled from making further purchases;
storing an indication as to the amount the first card is funded for or is to be funded for in making a transaction;
causing funds to be transferred to fund the purchase transaction to the lesser of a transaction amount for a first transaction made using the first card and the funding amount; and
causing a determination to be made if further use of the card in financial transactions is to be disabled based at least in part on the use indication.

34. The method as defined in claim 33, wherein the use indication indicates that the first card can only be used for a single transaction.

35. The method as defined in claim 33, wherein the use indication indicates that the first card can be used for a first plurality of transactions.

36. The method as defined in claim 33, further comprising storing at least a first merchant category identifier indicating at which merchants and/or merchant-types the first card is eligible for use.

37. The method as defined in claim 33, further comprising preventing the first card from being used to make additional purchases after the first transaction based at least in part on the use indication, wherein the first transaction is the initial transaction based with the first card.

38. The method as defined in claim 33, wherein the first card is distributed in or adjacent to a package for a product, and wherein the product is intended to be sold by a store.

39. The method as defined in claim 33, wherein the first card has at least one physical dimension that is not ISO 7810 compliant, and wherein the first card has an ISO 7811 compliant magnetic stripe storing data.

40. The method as defined in claim 33, wherein the first card has at least one physical dimension that is not ISO 7810 compliant, and wherein the first card has a magnetic stripe storing data that is not ISO 7811 compliant.

41. The method as defined in claim 33, wherein the first card is a debit card.

42. The method as defined in claim 33, wherein the first card is a credit card.

43. The method as defined in claim 33, wherein the first card is distributed as an employee reward and/or incentive.

44. The method as defined in claim 33, wherein the first card is distributed as a customer reward and/or incentive.

45. The method as defined in claim 33, wherein the first card is in a set of cards being distributed to promote an event, and wherein funds used to pay for transactions made using the set of cards are paid for by promoter of the event.

46. A method of securely activating a financial card, the method comprising:
receiving over a network a user identifier, user location information, and a financial card identifier for a financial card, wherein the financial card is a credit card or a debit card;
validating the financial card identifier;
reading a first set of eligibility information indicating at which merchants and/or merchant types the financial card are eligible to receive payment for transactions made using the financial card;
storing financial card identification information in association with the user identifier;
based at least in part on the user location information and eligibility information, determining if there are merchants within a first geographical area at which the financial card can be used;
if there are eligible merchants within the first geographical area, providing over the network location information regarding at least a first of the merchants to the user; and
if there are not eligible merchants within the first geographical area, enabling the use of card at a different merchant and/or merchant type based on a second set of eligibility information.

47. The method as defined in claim 46, wherein the second set of eligibility information is selected based at least in part on a selection by the user.

48. The method as defined in claim 46, wherein the first set of eligibility information indicates that the financial card is eligible for use at one or more movie theaters.

49. The method as defined in claim 46, wherein the geographical area is selected based on a distance from the user.

50. The method as defined in claim 46, further comprising enabling the financial card to be used as a coupon.

51. The method as defined in claim 46, further comprising storing in computer readable memory an indication that the financial card is distributed via packaging of a product, wherein the product is sold by a merchant.

52. The method as defined in claim 46, wherein the financial card is distributed via packaging for a food product, a cleaning product, a DVD, a CD, or an electronic product.

53. The method as defined in claim 46, wherein the financial card is not funded until a financial transaction authorization request is received over an electronic network.

54. A card dispensing apparatus, comprising:
a product package that contains food, a cleaning product, an electronic entertainment device, and/or media storing a movie or music; and
a debit card or a credit card, including a data storage device readable without physically contacting the data storage device, wherein the card is removably positioned in the product package and/or removably coupled to the product package.

55. The card dispensing apparatus as defined in claim 54, wherein the card is removable attached to the product package using adhesive.

56. The card dispensing apparatus as defined in claim 54, wherein the product package is a cardboard box and/or includes plastic.

57. The card dispensing apparatus as defined in claim 54, wherein the product package includes shrink wrapping.

58. The card dispensing apparatus as defined in claim 54, wherein the data storage device is in the form of a bar code.

59. The card dispensing apparatus as defined in claim 54, wherein the product is a food item or a cleaning product.

60. The card dispensing apparatus as defined in claim 54, wherein the card has a first image printed thereon, and the product package has a second image printed thereon, the first image and the second image related to a first movie.

61. The card dispensing apparatus as defined in claim 54, wherein the card has a movie identifier printed thereon.

62. The card dispensing apparatus as defined in claim 54, wherein the card has information printed thereon that the card is intended to be used to purchase admission to a movie.

63. The card dispensing apparatus as defined in claim 54, wherein the data storage device is a radio frequency data identification (RFID) storage device.

64. The card dispensing apparatus as defined in claim 54, wherein the product is positioned on a retail store product shelf.

65. The card dispensing apparatus as defined in claim 54, wherein the card is authorized for use at merchants having a Merchant Category Code specified by a first entity.

66. The card dispensing apparatus as defined in claim 54, wherein the card has a card value printed thereon.

67. The card dispensing apparatus as defined in claim 54, wherein the card does not have an end user name printed thereon.

68. The card dispensing apparatus as defined in claim 54, wherein the card is a debit card.

69. The card dispensing apparatus as defined in claim 54, wherein the card is a credit card.

70. The card dispensing apparatus as defined in claim 54, wherein the card is authorized for use in making a purchase after an end user provides requested information over a network via an electronic form.

71. A method of distributing a financial instrument, the method comprising:
providing a consumer with an authorization code via a product package, a product label, a coupon, or via a receipt for purchasing at least a first product or service;
receiving over a network the authorization code from the consumer;
determining if the authorization code is valid;
receiving over the network personal data from the consumer;
identifying to the consumer establishments that accept a first financial instrument,
wherein the first financial instrument is a debit instrument or a credit instrument;
storing a code associated with the first financial instrument in association with an identifier associated with consumer;
electronically providing over the network the first financial instrument to the consumer, wherein the financial instrument is configured to be printed using a printer coupled to a terminal.

72. The method as defined in claim 71, wherein the authorization code is provided via a bottle top.

73. The method as defined in claim 71, wherein the first financial instrument is printable on paper.

74. The method as defined in claim 71, the method further comprising determining if the consumer meets at least a first eligibility criteria.

75. The method as defined in claim 74, wherein the first eligibility criteria relates to a purchase amount.

76. The method as defined in claim 74, wherein the first eligibility criteria relates to a purchase quantity.

77. The method as defined in claim 71, wherein the personal data comprises at least in part contact information from the consumer.

78. The method as defined in claim 71, wherein determining if the authorization code is valid further comprises determining if the authorization code has previously been used within a specified time period.

79. The method as defined in claim 71, wherein determining if the authorization code is valid further comprises determining if the authorization code has previously been used.

80. The method as defined in claim 71, wherein the identified establishments are members of at least a first credit/debit card network.

81. The method as defined in claim 71, wherein the identified establishments are members of a credit/debit card network.

82. The method as defined in claim 71, the method further comprising determining which promotion the authorization code is associated with.

83. The method as defined in claim 71, the method further comprising determining if the authorization code is associated with a promotion for a movie.

84. The method as defined in claim 71, the method further comprising determining if the authorization code is associated with a promotion for a sound recording.

85. The method as defined in claim 71, the method further comprising determining if the authorization code is associated with a promotion for a household item.

86. The method as defined in claim 71, wherein the financial instrument, when printed includes a bar code.

87. The method as defined in claim 71, wherein the financial instrument, when printed, includes a name associated with the consumer.

88. The method as defined in claim 71, wherein the financial instrument, when printed, includes a debit code.

89. The method as defined in claim 71, wherein the financial instrument, when printed, includes a credit code.

90. The method as defined in claim 71, wherein the financial instrument does not comprise plastic.

91. The method as defined in claim 71, the method further comprising providing checking or debit account code-bearing media, wherein the media includes adhesive so that the media can be affixed to the financial instrument.

92. The method as defined in claim 91, wherein the checking or debit account code are provided in Magnetic Ink Character Recognition (MICR) format.

93. A method of distributing a financial instrument, the method comprising:
providing a consumer with an authorization code;
receiving over a network the authorization code from the consumer;
determining if the authorization code is valid; and
electronically providing over the network a first financial instrument to the consumer, wherein the financial instrument is printable by the user using a printer coupled to a terminal.

94. The method as defined in claim 93, wherein the authorization code is provided via packaging for a food item.

95. The method as defined in claim 93, wherein the first financial instrument is printable on paper.

96. The method as defined in claim 93, the method further comprising determining if the consumer meets at least a first eligibility criteria.

97. The method as defined in claim 96, wherein the first eligibility criteria relates to a purchase amount.

98. The method as defined in claim 96, wherein the first eligibility criteria relates to a purchase quantity.

99. The method as defined in claim 93, the method further comprising receiving contact information from the consumer prior to providing the first financial instrument to the consumer.

100. The method as defined in claim 93, wherein determining if the authorization code is valid further comprises determining if the authorization code has previously been used within a specified time period.

101. The method as defined in claim 93, wherein determining if the authorization code is valid further comprises determining if the authorization code has previously been used.

102. The method as defined in claim 93, wherein the identified establishments are members of at least a first credit/debit card network.

103. The method as defined in claim 93, wherein the identified establishments are members of a credit/debit card network.

104. The method as defined in claim 93, the method further comprising determining which promotion the authorization code is associated with.

105. The method as defined in claim 93, the method further comprising determining if the authorization code is associated with a promotion for a movie.

106. The method as defined in claim 93, the method further comprising determining if the authorization code is associated with a promotion for a sound recording.

107. The method as defined in claim 93, the method further comprising determining if the authorization code is associated with a promotion for a household item.

108. The method as defined in claim 93, wherein the financial instrument, when printed, includes a bar code.

109. The method as defined in claim 93, wherein the financial instrument, when printed, includes a name associated with the consumer.

110. The method as defined in claim 93, wherein the financial instrument, when printed, includes a debit code.

111. The method as defined in claim 93, wherein the financial instrument, when printed includes a credit code.

112. The method as defined in claim 93, wherein the financial instrument does not comprise plastic.

113. The method as defined in claim 93, the method further comprising providing checking or debit account code-bearing media, wherein the media includes adhesive so that the media can be affixed to the financial instrument.

114. The method as defined in claim 113, wherein the checking or debit account code are provided in Magnetic Ink Character Recognition (MICR) format.
